(19) United States
(12) Patent Application Publication
(10) Pub. No.: US 2009/0270275 A1
(43) Pub. Date: Oct. 29, 2009

(54) METHOD AND APPARATUS FOR SCANNING BIO CHIPS USING LIGHT AMPLICATION BY METAL NANO-PARTICLES

(75) Inventors: Kang Ho PARK, Daejeon (KR); Sung Q Lee, Daejeon (KR); Seung Eon Moon, Daejeon (KR); Hyung Kun Lee, Daejeon (KR); Soo Kyung Kim, Gimpo-si (KR)

Correspondence Address: AMPACC LAW GROUP, 3500 188th St. SW, Lynnwood, WA, 98037, US

(73) Assignees: Electronics and Telecommunications Research Institute, Daejeon (KR); NANOstorage Co., Ltd., Seoul (KR)

(21) Appl. No.: 12/355,590

(22) Filed: Jan. 16, 2009

(30) Foreign Application Priority Data
Apr. 25, 2008 (KR) 10-2008-38902

(51) Int. Cl. C40B 30/10; C40B 60/12

(52) U.S. Cl. 506/12; 506/39

(57) ABSTRACT

The present invention utilizes a principle in which, in a state in which metal nano-particles are attached to target probes and used as markers, and the metal nano-particles have a proper density according to a bio reaction between the target probes and fixed probes, when the metal nano-particles are irradiated with a laser beam having a proper intensity from the optical pick-up head, a higher optical energy is delivered to the phase change layer by an optical amplification effect caused by the metal nano-particles, thereby better inducing an amorphous-to-crystalline phase change.

### CROSS-REFERENCE TO RELATED APPLICATION

This application claims priority to and the benefit of Korean Patent Application No. 2008-38902, filed on Apr. 25, 2008, the disclosure of which is incorporated herein by reference in its entirety.

### BACKGROUND

1. Field of the Invention

The present invention relates to a method and apparatus for scanning a bio chip using light amplication by metal nano-particles, and more particularly, to a method and apparatus for scanning a bio chip that are capable of precisely detecting the presence or absence of a bio reaction by inducing a larger phase change of a phase change layer using light amplication by metal nano-particles attached to target probes.

2. Discussion of Related Art

A bio chip includes high-density biomolecule probes to be analyzed, such as DNA or protein, adhered to a substrate and can analyze gene expression pattern, gene defect, protein distribution, reaction pattern, and the like in a sample.

Depending on probes attachment forms, bio chips may be classified into microarray chips attached to a solid substrate and lab-on-a-chips probes attached to a microchannel.

To find out whether there are target probes that may be coupled to fixed probes on a substrate, the bio chip necessitates a system capable of detecting whether the fixed probes are coupled with the target probes.

Most DNA chips for gene analysis use laser-induced fluorescence (LIF) detection, in which a fluorescent dye is labeled on a sample DNA and can be reacted with probes on the chip, and a fluorescent material remaining on a surface of the chip is detected by a confocal microscope or a charge coupled device (CCD) camera, which uses a laser as a light source.

However, since a bio chip scanner using such laser-induced fluorescence (LIF) detection exhibits low fluorescent emission efficiency of fluorescent dyes Cy3 and Cy5, it disadvantageously necessitates a separate special detector for detecting a fluorescent signal such as a photomultiplier tube or an avalanche photodiode detector (APD).

To solve this problem, new methods for detection without using a fluorescent material are currently being researched.

One includes a method for confirming whether a bio reaction occurs based on reflectance/transmittance of light by using metal nano-particles having a light blocking effect as markers for bio materials.

More specifically, the metal nano-particles are used as markers and the phase change layer is used as a recording material and a phenomenon in which high-density distribution of the metal nano-particles leads to poor delivery of light energy to a phase change layer due to light scattering and blocking is used to record and reproduce bio information on the phase change layer.

However, when the metal nano-particles are used as markers only for the light blocking effect, low-density distribution of the metal nano-particles causes the low light blocking effect to have an influence on the phase change layer, and makes it difficult to confirm the presence or absence of the bio reaction by measuring light reflectance only.

Accordingly, there is a need for a scheme capable of detecting whether a bio reaction occurs, based on light reflectance using an optical pick-up head (OPUH) even when the metal nano-particles used as markers have a low density.

### SUMMARY OF THE INVENTION

The present invention is directed to a method and apparatus for scanning a bio chip, capable of precisely detecting whether a bio reaction occurs by using an optical pick-up head even when the metal nano-particles have a low density by inducing a larger phase change of a phase change layer using light amplication by metal nano-particles attached to the target probes.

The present invention is also directed to a method and apparatus for scanning a bio chip that are capable of performing precise detection at low cost and with a small-sized structure.

The present invention is also directed to a method for scanning a bio chip using light amplication by metal nano-particles, the method comprising: preparing the bio chip including a region having high-density metal nano-particles and a region having low-density metal nano-particles formed thereon according to whether target probes having metal nano-particles attached thereto are coupled through a bio reaction to fixed probes disposed on a phase change layer; irradiating the bio chip with a write laser beam having a predetermined intensity; selectively transmitting a near-field light through the region having high-density metal nano-particles to cause optical amplification as the write laser beam is irradiated onto the region having high-density metal nano-particles; inducing an amorphous-to-crystalline phase change of the phase change layer located below the region having high-density metal nano-particles, using the optical amplification; and recording bio information about a coupling state between the target probes and the fixed probes, on the phase change layer.

The method may further comprise: after recording the bio information on the phase change layer, irradiating a laser beam onto the bio chip to obtain a difference in reflectance of the phase change layer; and A/D-converting the obtained reflectance difference and reproducing the bio information recorded on the phase change layer according to a digital image obtained by the A/D conversion.

Another aspect of the present invention provides an apparatus for scanning a bio chip using light amplication by metal nano-particles, the apparatus comprising: the bio chip including a region having high-density metal nano-particles and a region having low-density metal nano-particles formed thereon according to whether target probes having the metal nano-particles attached thereto are coupled by a bio reaction to fixed probes disposed on a phase change layer; a write laser irradiation unit for recording bio information about a coupling state of the target probes to the fixed probes, on the bio chip; and a reproduction unit for reproducing and outputting the recorded bio information from the bio chip, wherein when a write laser beam having a predetermined intensity is irradiated from the write laser irradiation unit onto the bio chip, a near-field light is selectively transmitted through the region having high-density metal nano-particles to cause optical amplification, and an amorphous-to-crystalline phase change of the phase change layer located below the region having high-density metal nano-particles is induced by the optical amplification.

The features and advantages described herein are not all-inclusive and, in particular, many additional features and advantages will be apparent to one of ordinary skill in the art in view of drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 schematically illustrates a bio-chip scanning apparatus according to an embodiment of the present invention;

FIGS. 2a, 2b and 2c illustrate a method for scanning a bio chip according to an embodiment of the present invention;

FIG. 3 illustrates a graph showing high transmittance of near-field light in a region of high-density metal nano-particles; and

FIG. 4 is a graph showing, as a reflectance value, a degree of a phase change in the case where there are no metal nano-particles and the case where there is an optical amplification effect caused by a proper density of metal nano-particles.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order for this disclosure to be complete and enabling of practice of the invention by those of ordinary skill in the art.

The present inventors recognized that irradiation of a focused light for light reflectance measurement from an optical pick-up head to metal nano-particles results in a field enhancement effect in the metal nano-particles or a near-field optical amplification effect by surface plasmon absorption, which induces a large phase change of an underlying phase change layer, and completed the present invention.

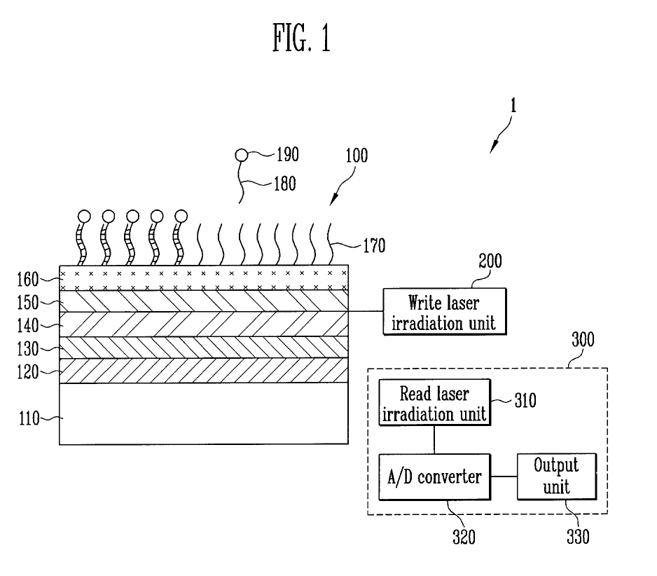

FIG. 1 schematically illustrates a bio-chip scanning apparatus according to an embodiment of the present invention.

Referring to FIG. 1, a bio-chip scanning apparatus 1 according to an embodiment of the present invention includes a bio chip 100 for detecting whether a bio reaction occurs, a write laser irradiation unit 200 for recording bio information on the bio chip 100, and a reproduction unit 300 for reproducing the recorded bio information from the bio chip 100 and outputting the bio information.

The bio chip 100 has a multi-layered structure in which a metal thin film 120, a first dielectric film 130, a phase change layer 140, a second dielectric film 150, and an insulating film 160 are sequentially stacked on a substrate 110. Here, an optical pick-up head (not shown) for a CD or a DVD may be used for recordation and reproduction.

The metal thin film 120 is formed of an optically reflective metal material having high reflectance, e.g., Al or Ag, etc. For light reflection, the metal thin film 120 may have a thickness of 10 to 100 nm.

The first and second dielectric films 130 and 150 may be formed of ZnS-doped SiO₂. The phase change layer 140 may be formed of a phase change material in a chalcogenide metal alloy group or in a germanium (Ge)-antimony (Sb)-tellurium (Te) group.

The insulating film 160 may be formed of an insulating material, such as SiO₂. Fixed probes 170 are fixed to the insulating film 160.

When the fixed probes 170 is fixed to the bio chip 100 and then metal nano-particles 190 are attached to and injected into target probes 180, the target probes 180 with the metal nano-particles 190 are coupled to the fixed probes 170. Here, the metal nano-particles 190 include gold, silver, or copper in a nano scale.

Accordingly, a portion where the target probes 180 are coupled to the fixed probes 170 and a portion where the target probes 180 are not coupled to the fixed probes 170 coexist in the bio chip 100, as shown in FIG. 1. As a result, the bio chip 100 having high-density metal nano-particles 190 only in a specific region according to the presence or absence of a bio reaction is produced.

Meanwhile, the write laser irradiation unit 200 irradiates a write laser beam onto the bio chip 100 to cause a phase change of the phase change layer 140, and disables a laser so that bio information about a coupling state of the target probes 180 is recorded on the phase change layer 140.

The reproduction unit 300 recognizes a reflectance caused by the phase change state of the phase change layer 140 by irradiating a read laser beam onto the bio chip 100, and reproduces and outputs the recorded bio information from the phase change layer 140.

Here, the reproduction unit 300 includes a read laser irradiation unit 310, an A/D converter 320, and an output unit 330, in which digital information from the A/D converter 320 is converted into an image and analyzed by a computer system.

Hereinafter, a method for scanning a bio chip according to an embodiment of the present invention will be described in greater detail.

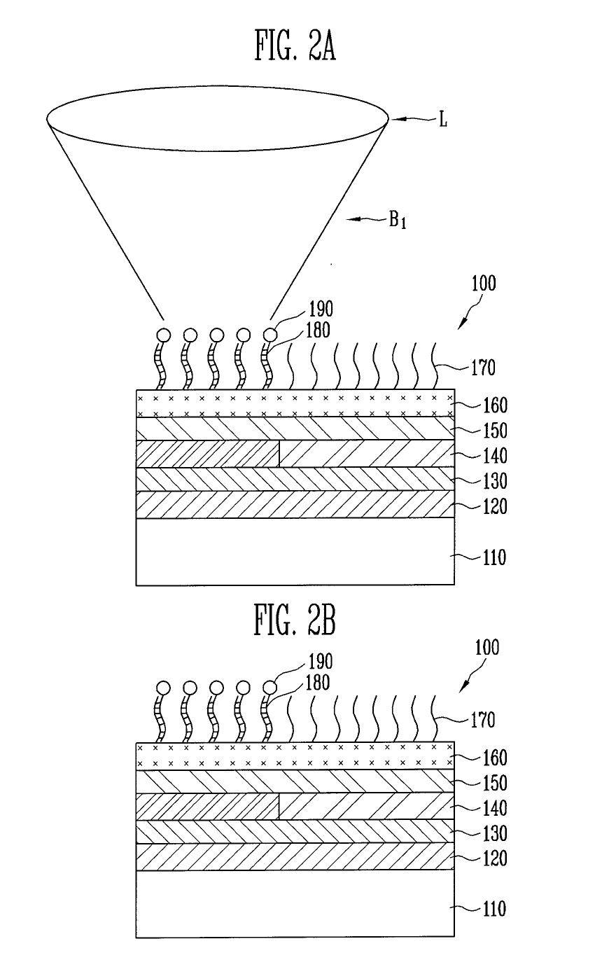

FIGS. 2a through 2c illustrate the method for scanning a bio chip according to an embodiment of the present invention.

Referring to FIG. 2a, first, a write laser beam B₁ focused by an objective lens L of an optical pick-up head (not shown) is irradiated onto the bio chip 100.

When the write laser beam B is irradiated onto the bio chip 100, as shown in the left of FIG. 2b, an optical amplification phenomenon involving an increase in optical energy delivered to the phase change layer 140 due to the metal nano-particles 190 attached to the target probes 180 is caused in a region where the target probes 180 are coupled to the fixed probes 170. This leads to a considerable phase change of the phase change layer 140.

On the other hand, the optical amplification phenomenon does not occur in a region where the target probes 180 are not coupled to the fixed probes 170 as shown in the right of FIG. 2b, leading to a smaller degree of phase change on the phase change layer 140. That is, the write laser beam B₁ is irradiated only onto the bio chip 100 without being amplified by the metal nano-particles 190, inducing a smaller degree of an amorphous-to-crystalline phase change on the phase change layer 140.

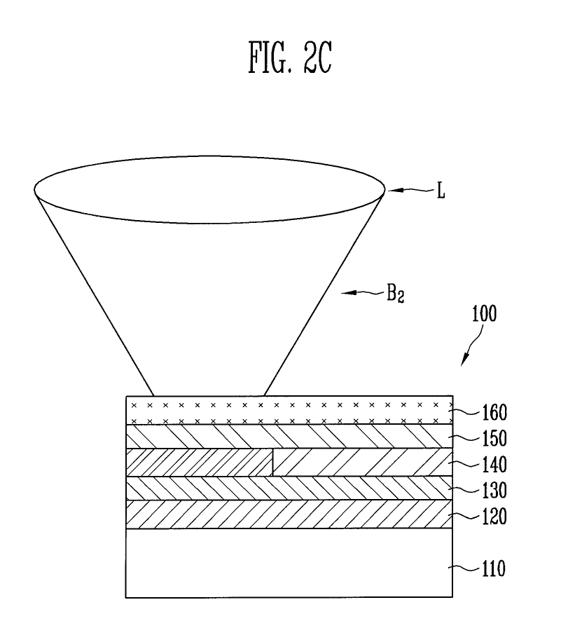

In this case, near-field light is selectively strongly transmitted only through the region having high-density metal nano-particles 190 as shown in the left of FIG. 2b, inducing a larger phase change of the underlying phase change layer 140. This will be described in greater detail with reference to FIG. 3.

FIG. 3 illustrates a graph showing high transmittance of near-field light in the region of high-density metal nano-particles 190.

Referring to FIG. 3, the transmittance of the near-field light does not show a considerable difference when the density of the metal nano-particles 190 is lower than a reference value n₁. However, when the density of the metal nano-particles 190 increases above the reference value n₁, an interval between the metal nano-particles 190 is made smaller and the transmittance of the near-field light delivered to the phase change layer 140 increases due to the field-enhancement effect or the surface plasmon absorption between the metal nano-particles 190. When the density of the metal nano-particles 190 further increases to nₛ, i.e., the extent that the metal nano-particles 190 are adhered to each other, the transmittance of the near-field light, rather, rapidly decreases due to the light blocking effect.

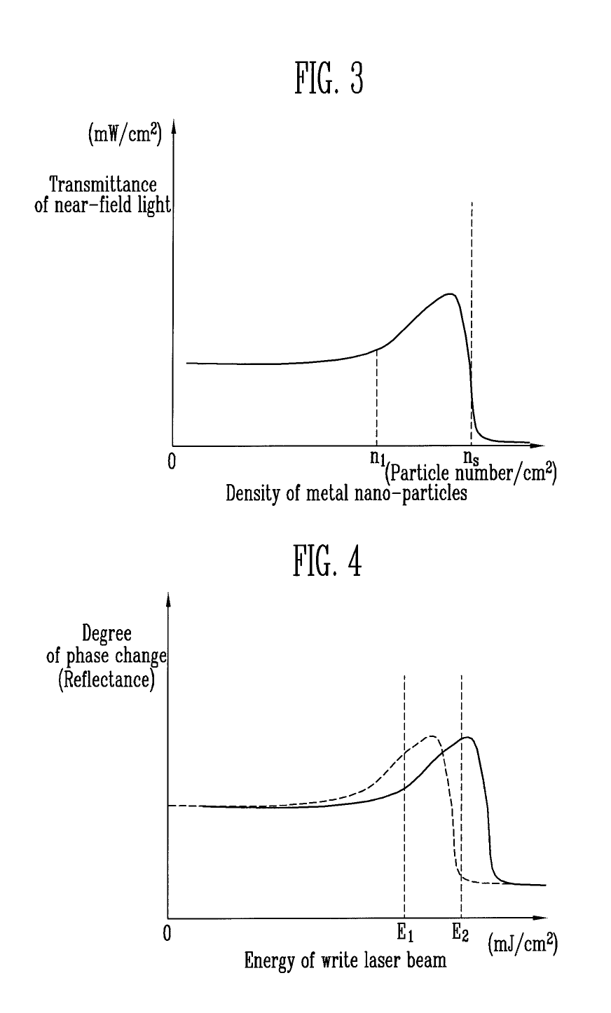

The optical amplification effect that the near-field light is selectively strongly transmitted only through the region of the metal nano-particles 190 having a proper density leads to high optical energy delivered to the phase change layer 140 below the metal nano-particles 190, thus inducing a larger phase change. This will be described in greater detail with reference to FIG. 4.

FIG. 4 is a graph showing, as a reflectance value, a degree of a phase change in the case where there are no metal nano-particles 190 (as indicated by a solid line) and the case where there is an optical amplification effect caused by a proper density of metal nano-particles (as indicated by a dotted line).

With reference to FIG. 4, under a condition that the same energy of a write laser beam is irradiated onto the amorphous phase change layer 140, the phase change layer 140 is highly crystallized and the phase change degree is larger in the case where there is the optical amplification effect caused by the proper density of the metal nano-particles 190 (as indicated by a dotted line). However, when the energy of the write laser beam exceeds a threshold, such excessive energy of the write laser beam may damage the phase change layer 140, leading to a smaller degree of the phase change from an amorphous state.

That is, a difference in the phase change degree of the phase change layer 140 between presence and absence of the metal nano-particles 190 can be maximized by applying proper optical energies E₁ and E₂ through adjustment of the intensity and width of the laser pulse according to the density of the metal nano-particles 190.

Thus, by obtaining the proper energy value of the laser beam according to the density of the metal nano-particles 190 through an experiment and irradiating the laser beam having the obtained optical energy onto the bio chip 100, the phase change degree of the phase change layer 140 greatly depends on whether the bio reaction between the fixed probes 170 and the target probes 180 occurs.

In this state, when the laser is disabled, the phase change layer 140 is cooled to maintain a phase change state and minor bio information about a coupling state between the target probes 180 and the fixed probes 170 is recorded as it is on the underlying phase change layer 100.

The bio chip 100 having the bio information recorded in the above process may be used without being processed or may be used after bio materials or metal nano-particles on the surface are all eliminated by a cleaning process.

As described above, after the metal nano-particles 190 have a proper density according to the bio reaction between the target probes 180 and the fixed probes 170, irradiation of a write laser beam B₁ having a proper intensity from the optical pick-up head onto the metal nano-particles 190 causes higher optical energy to be delivered to the phase change layer 140 by an optical amplification effect of the metal nano-particles 190, thus better inducing an amorphous-to-crystalline phase change.

In a conventional bio-chip scanning scheme, it is possible to confirm whether a bio reaction occurs, using a light blocking effect only when the metal nano-particles have a high density, while, in the present invention, since a minor bio reaction can lead to a higher phase change degree of the phase change layer 140 even when the metal nano-particles 190 have a somewhat low density, precise bio information resulting from the minor bio reaction can be recorded on the bio chip 100.

The precision can also be adjusted according to the intensity of the write laser beam, which depends on the density of the metal nano-particles 190 determined by the bio reaction, resulting in a bio-chip scanning apparatus of a simple structure capable of precise detection.

Meanwhile, a read laser beam B₂ is irradiated onto bio chip 100 having the bio information recorded by the above process, through an objective lens L of an optical pick-up head (not shown), as shown in FIG. 2c.

The read laser beam B₂ irradiated onto the bio chip 100 is reflected from the phase change layer 140 with the reflectance thereof determined according to whether the bio reaction occurs, and input to an optical detector (not shown) of the optical pick-up head. A reflectance difference is converted and output into a digital image by the A/D converter 320. The bio information is reproduced from the phase change layer 140 according to the digital image obtained by the A/D converter 320.

Consequently, since the difference in the reflectance of the phase change layer 140 indicates both the presence or absence and the degree of the bio reaction, desired DNA information can be obtained or disease diagnosis can be made by analyzing such information.

Finally, the bio chip 100 is irradiated with the laser beam and initialized after the bio information is read from the bio chip 100. The initialized bio chip 100 allows for iterative detection.

Thus, a conventional bio-chip scanning scheme necessitates a separate high-precision optical detector because the determination as to whether the bio reaction occurs cannot be made by only the light reflectance measurement, while in the present invention, the reflectance of the phase change layer 140 can be measured by only the optical detector of the optical pick-up head, allowing the recorded bio information to be easily detected from the phase change layer 140. This makes a separate high precision optical detector unnecessary and results in an inexpensive and small-sized apparatus.

According to an embodiment of the present invention, when metal nano-particles are attached to the target probes to be used as markers, a very large phase change of the phase change layer is induced by a minor bio reaction between the target probes and the fixed probes even when the metal nano-particles have a low density, thereby precisely detecting presence or absence of the minor bio reaction. This is because, when the metal nano-particles having a proper density according to the bio reaction between the target probes and the fixed probes are irradiated with a laser beam having a proper intensity from the optical pick-up head, a higher optical energy is delivered to the phase change layer by an optical amplification effect caused by the metal nano-particles, better inducing an amorphous-to-crystalline phase change.

According to an embodiment of the present invention, the detection precision can be simply adjusted according to the intensity of the laser beam, which depends on the density of metal nano-particles determined by the bio reaction, resulting in a bio-chip scanning apparatus capable of performing precise detection with a simple structure.

According to an embodiment of the present invention, the bio information from the phase change layer can be easily detected by measuring the reflectance of the phase change layer only with an optical detector of an optical pick-up head, thereby making a separate high-precision optical detector unnecessary. This results in an inexpensive, small structure of the apparatus.

According to an embodiment of the present invention, the bio reaction can be more clearly detected at higher sensitivity and accuracy, as compared to use of a fluorescent signal, thus assuring excellent performance of a diagnosis scanner.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for scanning a bio chip using light amplication by metal nano-particles, the method comprising:
preparing the bio chip including a region having high-density metal nano-particles and a region having low-density metal nano-particles formed thereon according to whether target probes having metal nano-particles attached thereto are coupled through a bio reaction to fixed probes disposed on a phase change layer;
irradiating the bio chip with a write laser beam having a predetermined intensity;
selectively transmitting a near-field light through the region having high-density metal nano-particles to cause optical amplification as the write laser beam is irradiated onto the region having high-density metal nano-particles;
inducing an amorphous-to-crystalline phase change of the phase change layer located below the region having high-density metal nano-particles, using the optical amplification; and
recording bio information about a coupling state between the target probes and the fixed probes, on the phase change layer.

2. The method of claim 1, wherein the metal nano-particles are any one of gold, silver, and copper.

3. The method of claim 1, wherein the irradiating the bio chip with a write laser beam further comprises changing intensity of the write laser beam irradiated onto the bio chip, according to density of the region having high-density metal nano-particles.

4. The method of claim 1, wherein the selectively transmitting a near-field light further comprises inducing the amorphous-to-crystalline phase change of the phase change layer located below the region including low-density metal nano-particles due to energy of the write laser beam as the write laser beam is irradiated onto the region including low-density metal nano-particles.

5. The method of claim 1, further comprising: after recording the bio information on the phase change layer,
irradiating a laser beam onto the bio chip to obtain a difference in reflectance of the phase change layer; and
A/D-converting the obtained reflectance difference and reproducing the bio information recorded on the phase change layer according to a digital image obtained by the A/D conversion.

6. The method of claim 5, wherein the difference in reflectance of the phase change layer depends on the presence or absence and the degree of the bio reaction.

7. An apparatus for scanning a bio chip using light enhanced by metal nano-particles, the apparatus comprising:
the bio chip including a region having high-density metal nano-particles and a region having low-density metal nano-particles formed thereon according to whether target probes having the metal nano-particles attached thereto are coupled by a bio reaction to fixed probes disposed on a phase change layer;
a write laser irradiation unit for recording bio information about a coupling state of the target probes to the fixed probes, on the bio chip; and
a reproduction unit for reproducing and outputting the recorded bio information from the bio chip,
wherein when a write laser beam having a predetermined intensity is irradiated from the write laser irradiation unit onto the bio chip, a near-field light is selectively transmitted through the region having high-density metal nano-particles to cause optical amplification, and an amorphous-to-crystalline phase change of the phase change layer located below the region having high-density metal nano-particles is induced by the optical amplification.

8. The apparatus of claim 7, wherein the bio chip has a structure in which a metal thin film, a first dielectric film, the phase change layer, a second dielectric film, and an insulating film are sequentially formed on a substrate.

9. The apparatus of claim 7, wherein the metal nano-particles are any one of gold, silver, and copper.

10. The apparatus of claim 7, wherein the write laser irradiation unit disables the write laser beam after the phase change of the phase change layer is made, so that the bio information about a coupling state of the target probes to the fixed probes is recorded on the phase change layer.

11. The apparatus of claim 7, wherein the write laser irradiation unit changes the intensity of the write laser beam irradiated onto the bio chip, according to density of the region having high-density metal nano-particles.

12. The apparatus of claim 7, wherein when the write laser beam having a predetermined intensity is irradiated from the write laser irradiation unit onto the bio chip, an amorphous-to-crystalline phase change of the phase change layer located below the region having low-density metal nano-particles is induced by energy of the write laser beam.

13. The apparatus of claim 7, wherein the reproduction unit further comprises:
a read laser irradiation unit for irradiating a read laser beam onto the bio chip and obtaining a difference in reflectance of the phase change layer using an optical detector; and
an A/D converter for A/D converting the reflectance difference obtained by the read laser irradiation unit and outputting a digital image.

14. The apparatus of claim 13, wherein the difference in reflectance of the phase change layer depends on the presence or absence and the degree of the bio reaction.
